(19) United States
(12) Patent Application Publication
(10) Pub. No.: US 2011/0221868 A1
(43) Pub. Date: Sep. 15, 2011

(54) Information Reproducing Apparatus

(75) Inventors: Julian Daubrawa, Muenchen (DE); Stefan Erker, Wessling (DE); Michael Felux, Wessling (DE); Gunther Melitón, Tres Cantos (Madrid) (ES); Arnaud van Kleef, Marknesse (NL)

(73) Assignee: Astrium GmbH, Taufkirchen (DE)

(21) Appl. No.: 13/043,959

(22) Filed: Mar. 9, 2011

(30) Foreign Application Priority Data
Mar. 10, 2010 (DE) 102010010951.7-54

(51) Int. Cl. H04N 13/02; H04N 7/18

(52) U.S. Cl. 348/47; 348/116; 348/E13.074

(57) ABSTRACT

An information reproducing apparatus includes a display unit and processing unit. The information reproducing apparatus has a position determining device configured to determine the position and alignment of the apparatus and to supply a first signal representing the position and a second signal representing the alignment to the processing unit. The processing unit retrieves information on objects from a database and processes the information. The database includes a plurality of information on objects of locations within a predefined spatial environment. The processing unit determines information for the current alignment of the apparatus on objects in the direction of the alignment of the apparatus and the display unit displays the information.

### CROSS REFERENCE TO RELATED APPLICATIONS

This application claims priority under 35 U.S.C. §119 to German Patent Application No. 10 2010 010 951.7-54, filed Mar. 10, 2010, the entire disclosure of which are herein expressly incorporated by reference.

### BACKGROUND AND SUMMARY OF THE INVENTION

The present invention relates to an information reproducing apparatus comprising a display unit for displaying information, a processing unit and a position determining device.

Information reproducing apparatuses such as, e.g. computers, laptops, PDAs (personal digital assistant), smartphones and the like allow a user to retrieve information on objects of locations from databases such as, e.g., local storage or information sources on the internet. If the information reproducing apparatus is provided with a position determining device such as a GPS receiver, information on objects in the environment of the information reproducing apparatus can also be displayed automatically by using the current position of the information reproducing apparatus. Information on objects of locations is also designated as points of interest (POI).

Services for displaying POIs are provided, for example, in motor vehicles or also by the map service of Google. The users of these services have the advantage that they receive information on objects of locations in the environment without a time-consuming search. A disadvantage of these systems is that they are static, i.e. the user has to associate the information displayed in the information reproducing apparatus with the real environment.

Exemplary embodiments of the present invention provide an information reproducing apparatus with an improved functionality for reproducing location-related information. Exemplary embodiments of the present invention also provide an improved method for operating an information reproducing apparatus.

The invention provides an information reproducing apparatus comprising a display unit for displaying information, a processing unit and position determining device. The processing unit is coupled with the display unit and provides the information to be displayed to the display unit. The position determining device is configured to determine the position of the apparatus as well as the alignment of the apparatus and to supply a first signal representing the position and a second signal representing the alignment to the processing unit for further processing. The processing unit is configured to retrieve and process information on objects from a database, wherein the database comprises a plurality of information on objects of locations within a predefined spatial environment. The processing unit is further configured to determine information for the current alignment of the apparatus on objects in the direction of the alignment of the apparatus and to display the information on the display unit.

Alignment of the information reproducing apparatus is to be understood, for example, as an actual or desired viewing direction of a user of the information reproducing apparatus. Due to the fact that only such information on objects in the direction of the alignment is displayed for the user on the information reproducing apparatus that is relevant for the alignment, i.e. the user's viewing direction, in the direction of the alignment of the apparatus, the user is not required to associate the information provided on the display unit with the real environment. This results in an improved user-friendliness.

For determining the position and alignment of the apparatus, the position determining device comprises, according to an embodiment, at least two antennas of a global satellite navigation system that are coupled with a receiver of the global navigation satellite system (a so-called GNSS receiver) for determining the position and alignment of the apparatus. For the determination of information on objects in the direction of the alignment and presentation on the display unit, it is sufficient if the alignment of the apparatus is determined only in the horizontal. This is referred to as “heading”. In this embodiment it is sufficient if the information reproducing apparatus comprises two antennas of the global navigation satellite system. If a complete position of the apparatus in space is to be determined, the position determining device must have three antennas.

The determination of the alignment of the apparatus, i.e., of the desired viewing direction of a user of the information reproducing apparatus can be carried out, for example, by a simultaneous carrier phase measurement of the two or, respectively, three antennas arranged relative to at least two satellites of the global navigation satellite system. An increasingly higher accuracy can be achieved in that the simultaneous carrier phase measurement for the two or three antennas is determined relative to as many satellites as possible.

The at least two antennas are arranged at a known distance from each other on or in the information reproducing apparatus. The distance between the phase centers of the antennas must be known more precisely. It was found to be sufficient if the distance between in each case two antennas is approximately 10 cm. Hereby, a sufficient accuracy for the determination of the alignment is achieved.

The position determining device could alternatively be configured to perform the determination of the position by using other wireless communication technologies. Thus, it can optionally be provided to implement this using wireless communication networks. The alignment could be determined with a compass function/unit.

According to a further advantageous configuration, the position determining device comprises at least one further sensor for the position and alignment determination of the information reproducing apparatus. The further sensor can be, for example, a gyroscope which increases the accuracy during the determination of the alignment.

In a further configuration of the invention, the database is arranged in a local storage of the information reproducing apparatus. The local storage can be fixedly integrated in the information reproducing apparatus. Also, the local storage can be implemented in the form of a memory card, e.g., a secure digital (SD) memory card, which can be inserted into the information reproducing apparatus. Depending on the size of the database, the latter can be arranged distributed over a plurality of such memory cards so that the user has first to connect the memory card necessary for the respective environment to the information reproducing apparatus to allow the processing unit to access the data on the card.

Alternatively or additionally, the database can be arranged in a further storage which is accessible in particular via a wireless communication link. The further storage can be, for example, a database provided by the service provider. Also, the database can be formed by information available on the internet. The communication link between the information reproducing apparatus and the further storage can be implemented, for example, via WLAN (Wireless Local Area Network), a GSM (Global System for Mobile Communication) link, or a UMTS (Universal Mobile Telecommunication System) link. Moreover, other communication techniques that allow the transmission of the data required by the processing unit for providing information on objects can also be used.

In a further advantageous configuration, the information reproducing apparatus comprises an imaging unit which supplies the processing unit with video data of the environment for processing and displaying the data on the display unit or a further display unit. It is to be understood that the imaging unit records video data of the environment in the direction of the alignment of the apparatus. The imaging unit comprises, in particular, two recording units for the generation of a stereo image so that the recorded data can be displayed three-dimensionally. To make it as easy as possible for the user to use the information on objects in the direction of the alignment of the apparatus it is further provided that the information on the objects is superimposed on the video data on the display unit. In this manner, the user is not required to carry out an allocation of the information on the objects to the environment reproduced in the video data.

Advantageously, the information on the objects is of a graphic or alphanumeric nature and can optionally be displayed and/or hidden on the display unit.

The information reproducing apparatus can optionally be portable or can be arranged in a transport mechanism.

In a particular configuration, the information reproducing apparatus can be binoculars, a camera, a PDA (Personal Digital Assistant), a telephone, a computer (e.g. a portable computer such as a laptop or netbook or Tablet PC) or an assistance system in a vehicle or aircraft.

The invention further provides a method for operating an information reproducing apparatus which comprises a display unit for displaying information, a processing unit coupled with the display unit and a position determining device. In the method according to the invention, the position determining device determines the position of the apparatus as well as an alignment of the apparatus. A first signal representing the position and a second signal representing the alignment are supplied to the processing unit for further processing. Further, information on objects is retrieved by the processing unit from the database, wherein the database comprises a plurality of information on objects of locations within a predefined spatial environment. The processing unit determines information for the current alignment of the apparatus on objects in the direction of the alignment of the apparatus and transmits the information to the display unit for displaying the information.

The method according to the invention has the same advantages as the ones described in connection with the information reproducing apparatus according to the invention.

In an advantageous configuration, the determination of the alignment of the apparatus takes place by a simultaneous carrier phase measurement of at least two antennas of the position determining device, wherein said antennas are arranged relative to a satellite.

Other objects, advantages and novel features of the present invention will become apparent from the following detailed description of one or more preferred embodiments when considered in conjunction with the accompanying drawings.

### BRIEF DESCRIPTION OF THE DRAWINGS

The invention is explained in more detail hereinafter by means of an exemplary embodiment in the drawing. In the figures:

FIG. 1 shows a schematic illustration of an information reproducing apparatus according to the invention,

FIG. 2 shows the principle for position and alignment determination underlying an information reproducing apparatus according to the invention, according to an embodiment variant,

FIG. 3 shows an exemplary illustration of a view recorded by an information reproducing apparatus at its position in a selected alignment,

FIG. 4 shows the view illustrated in FIG. 3 of the environment of the information reproducing apparatus, wherein the view is provided with information on objects in the direction of the alignment of the apparatus.

### DETAILED DESCRIPTION OF THE DRAWINGS

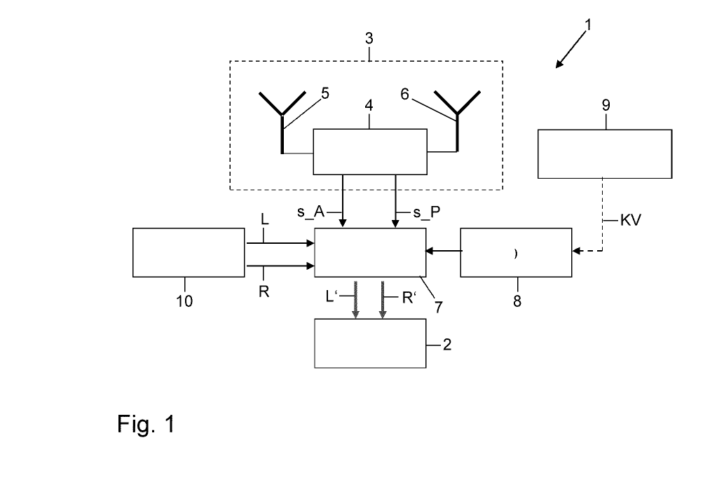

FIG. 1 shows in a schematic illustration the basic structure of an information reproducing apparatus 1 according to the invention. The information reproducing apparatus 1 can involve, for example, binoculars, a camera, a portable computer, a telephone or a PDA (Personal Digital Assistant).

The information reproducing apparatus is equipped with a display unit 2 for displaying information. The unit can be configured for displaying the information in high-resolution quality. In particular, the display unit can be designed as a display.

The display unit 2 is connected to a processing unit 7 (so-called core processing unit) which provides the information to be displayed to the display unit. The processing unit can be any type of processing unit, such as, a microprocessor. The processing unit can be programmed to perform any of the functions described as being performed by the processing unit herein, and the programming can occur using a program stored a non-transitory computer-readable medium. The information transferred from the processing unit 7 to the display unit 2 and to be displayed by the latter are designated with L′ and R′. The processing unit 7, in turn, is coupled with a position determining device 3.

In the present exemplary embodiment, the position determining device 3 comprises two antennas 5, 6 of a global navigation satellite system, the antennas being arranged at a known distance. The antennas 5, 6 are connected to a receiver 4 of the global navigation satellite system. The receiver 4, which is also designated as GNSS receiver, is configured for determining the position and alignment of the apparatus 1. The receiver 4 of the position determining device 3 supplies a first signal s_P representing the position and a second signal s_A representing the alignment to the processing unit 7 for further processing.

The alignment of the information reproducing apparatus is to be understood as an actual direction of the apparatus which usually corresponds to a desired viewing direction of a user of the information reproducing apparatus 1. To make the alignment easier or possible for a user of the information reproducing apparatus it can be provided that an axis to be used for the alignment is indicated on the apparatus.

With the two antennas 5, 6 of the position determining device 3, the determination of an alignment of the information reproducing apparatus 1 in the horizontal is possible. This is designated as “heading”. If a complete position, i.e. alignment, of the apparatus in space is to be determined, in contrast to the illustration in the drawing, the position determining device 3 would have to be equipped with three antennas of a global navigation satellite system which are arranged at a defined distance from each other.

If the information reproducing apparatus—as illustrated in the exemplary embodiment of FIG. 1—comprises only an optional imaging unit 10 (e.g. a video camera) which provides video data L, R of the environment to the processing unit 7 for processing and displaying on the display unit 2, the alignment corresponds to the optical axis of the imaging unit 10. In the exemplary embodiment, the imaging unit 10 is configured as stereo camera which records video data for a left channel L and a right channel R and supplies the data to the processing unit 7 for displaying a three-dimensional image.

The information reproducing apparatus 1 can, in exemplary embodiments, be equipped with an internal data storage 8 comprising a database with a plurality of information on objects of locations within a predefined spatial environment. The data storage 8 can be a storage which is fixedly provided in the information reproducing apparatus 1. Also, the storage can be configured in the form of a memory card, e.g. SD memory card, which can be inserted into the information reproducing apparatus 1.

Alternatively or additionally, the information on objects can be retrieved from an external database 9. Access to the external database 9 is possible, for example, via a wireless communication link. The type of the used communication link is arbitrary here. In particular, WLAN, GSM or UMTS communication links are possible.

The processing unit 7 is configured to determine information for the current alignment on objects in the direction of the alignment of the apparatus and to display the information on the display unit. In particular, the information on objects in the direction of the apparatus is superimposed on the video data recorded by the imaging unit.

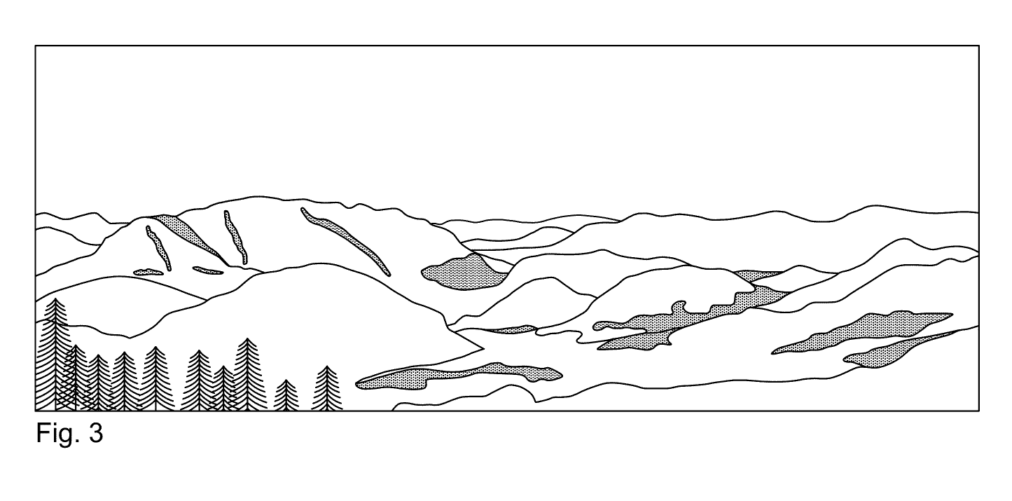

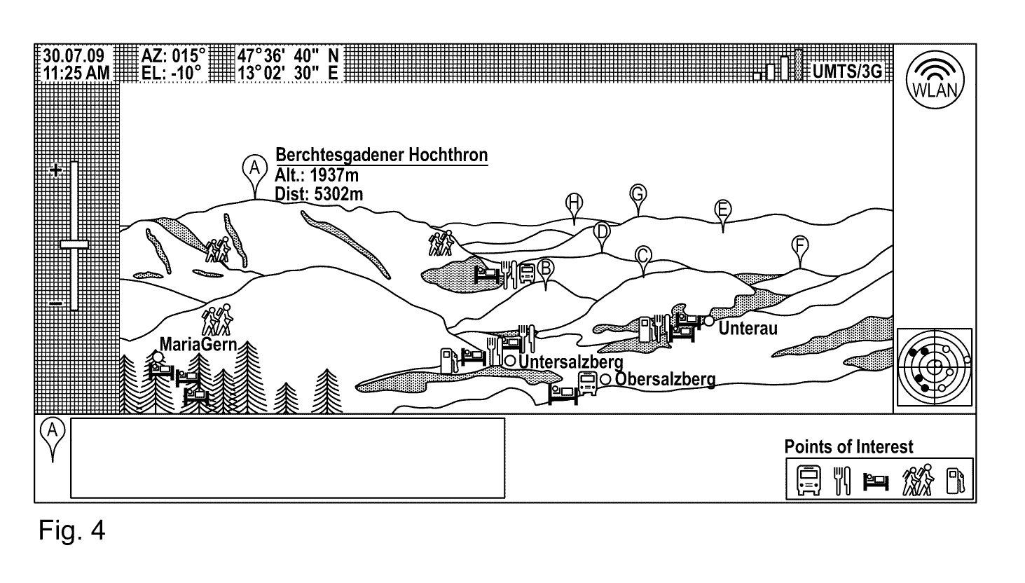

This is exemplary illustrated in the FIGS. 3 and 4. FIG. 3 shows an image recorded by the imaging unit 10 of the information reproducing apparatus 1. This image could be output, for example, on the display unit 2 of the information reproducing apparatus 1 configured as binoculars. On the basis of the position and the alignment of the information reproducing apparatus, the processing unit 7 can determine which information is contained in the video data and can be annotated.

The processing unit 7 retrieves information for the current position and alignment of the apparatus on objects in the direction of the alignment of the apparatus from one or both of the data storages 8, 9. The information is then directly integrated in the image recorded by the imaging unit 10 and displayed on the display unit 2. This is exemplary illustrated in FIG. 4.

Above the image, the geographic data of the position and alignment of the information reproducing apparatus 1 is illustrated. An azimuth angle is illustrated as AZ which is 015° in the exemplary embodiment. An elevation angle is designated with EL which is −10° in the exemplary embodiment. Moreover, the geographic position of the information reproducing apparatus 1 is visualized: 47° 36′ 40″ N and 13° 02′ 30″ E. Moreover, reception to a UMTS/3 G communication network is signalized to the user. In the same manner, an existing connection to a WLAN communication network is illustrated.

The image shows, for example, that the mountain illustrated at A in the left half of the image is the “Berchtesgadener Hochthron”. In addition, the altitude (Alt.: 1937 m”) and the distance of the latter from the current position of the information reproducing apparatus (“Dist: 5302 m”) is illustrated. Furthermore, the towns “Maria Gem”, “Untersalzberg”, “Obersalzberg” and “Unterau” are indicated in the image. At the locations illustrated with B, C, D, E, F, G, H, there is further information on the objects. In the lower right half of the image of FIG. 4, symbols are illustrated for so-called “points of interest” which offer the viewer of the display unit information about a railway station, restaurants, inns and/or hotels, hiking trails and gas stations. In the left half of the image, a zoom factor is illustrated which can be varied by the user (“Zoom: 10×”).

When reference is made in the present description to a determination of information on objects in the direction of the alignment of the apparatus for the current alignment of the apparatus by the processing unit, this is to be understood such that the processing unit 7 itself determines the relevant information based on the information about the position and alignment received from the position determining device 3, i.e. the processing unit retrieves actively and systematically information from the database or databases of the data storage 8 and/or 9. Also, the processing unit 7 can send the information about position and alignment to the database which uses said information for the search for the relevant information and subsequently sends the results back to the processing unit 7.

The information on objects of locations within a predefined spatial environment can principally be of alphanumeric and/or graphic nature. For example, the data can comprise the silhouette of mountains and/or objects when the latter are surrounded by fog. Data can comprise information about locations situated within the field of vision, i.e. alignment, of the information reproducing apparatus. The type of information can principally be of any nature.

The determination of the alignment of the information reproducing apparatus takes place by the position determining device 3. By the latter, a simultaneous carrier phase measurement of the two or more antennas of the position determining device 3 is carried out. Two antennas are necessary to determine only the horizontal alignment (heading) of the information reproducing apparatus 1. Three antennas are necessary to determine a complete position of the information reproducing apparatus 1 in space.

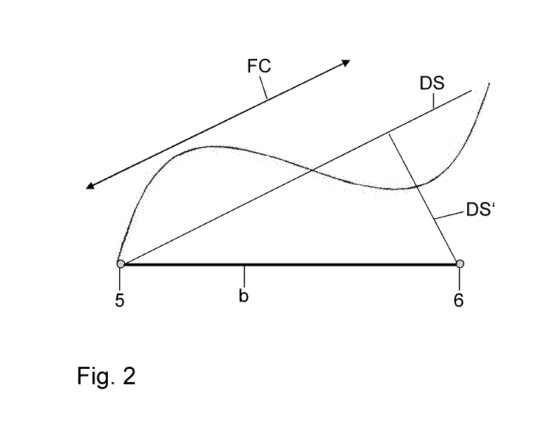

The following description refers to the use of only two antennas as illustrated in the exemplary embodiment of FIG. 1. First, a differential carrier phase of the two antennas 5, 6 to a satellite (not illustrated) is determined. Said differential carrier phase is designated as “single difference” or “fraction of a cycle” and is designated in FIG. 2 with FC. In this figure, DS designates the axis of the alignment of the information reproducing apparatus 1 with a satellite of the global navigation satellite system. b represents the distance between the antennas 5, 6 which is preferably as large as possible but not smaller than 10 cm. DS' is the minimum distance of the antenna 6 from the axis DS, i.e., DS' is arranged perpendicular to DS.

The differential carrier phase is determined by the following equation:

Δφ₁−Δφ₂=\vec{b}·\vec{e}+Nλ,

wherein φ₁ and φ₂ are the measured carrier phases of the antennas 5, 6. \vec{b} represents the so-called baseline vector of antenna 5 to antenna 6, \vec{e} represents a unit vector which points from the antennas 5, 6 to the satellite. The difference between the unit vectors of antenna 5 and antenna 6 is so low that the same is negligible. N represents an integer which describes the number of whole waves with the wave length λ.

In order to exclude satellite and receiver clock errors, double differences DD between two antennas and two satellites are formed:

DD=Δφ₁−Δφ₂=\vec{b}(\vec{e}₁−\vec{e}₂)+(N₁−N₂)λ.

Subsequently, N is determined, e.g., with the aid of the known LAMBDA method. The baseline vector b is determined using the double difference. This is possible with one double difference assumed that information about the position of the vector (e.g. horizontal) and its length is available in advance. If this is not the case, two or three double differences are needed. The described method is known per se and can be extended with three antennas to any three-dimensional case.

The described method is only an exemplary embodiment for determining the alignment of the information reproducing apparatus. It is principally possible to carry out the position determination in many different ways. However, the relative positioning by carrier phase measurements and the use of already known information such as, e.g., the distance between the antennas 5, 6 is common in all methods.

To find an improved position determination or determination of the alignment of the information reproducing apparatus 1 it can further be provided to provide additional sensors in the information reproducing apparatus 1. Such a sensor can be, for example, a gyroscope.

The information reproducing apparatus according to the invention provides a simple manner for associating information on objects of locations within a predefined spatial environment with an image recorded by the information reproducing apparatus. In particular, when the alignment of the information reproducing apparatus changes, the information on objects actually relevant for the alignment is dynamically displayed.

The predefined spatial environment can involve a global or regionally limited region. The predefined spatial environment can also involve a company grounds or a large building or a building complex.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE LIST

1 information reproducing apparatus
2 display unit
3 position determining device
4 receiver of the global navigation satellite system (GNSS receiver)
5 antenna
6 antenna
7 processing unit
8 database
9 database
10 imaging unit
s_A second signal
s_P first signal
L first video data
R second video data
L′ the information transferred from the processing unit
R′ the information transferred from the processing unit
KV wireless communication link

What is claimed is:

1. An information reproducing apparatus, comprising:
a display unit that displays information;
a processing unit coupled with the display unit to provide information displayed on the display unit;
a position determining device that determines a position and alignment of the information reproducing apparatus, the position determining device supplying to the processing unit a first signal representing the determined position and a second signal representing the determined alignment;
wherein the processing unit is configured
to retrieve information on objects from a database and to process the information, wherein the database comprises a plurality of information on objects of locations within a predefined spatial environment, and
to determine information on objects in a direction of the determined alignment of the information reproducing apparatus and to provide the determined information to the display unit.

2. The information reproducing apparatus according to claim 1, wherein the position determining device comprises at least two antennas of a global navigation satellite system, the two antennas being coupled with a receiver of the global navigation satellite system for determining the position and alignment of the apparatus.

3. The information reproducing apparatus according to claim 2, wherein the at least two antennas are arranged at a predetermined distance from each other on, or in, the information reproducing apparatus.

4. The information reproducing apparatus according to claim 1, wherein the position determining device comprises at least one further sensor.

5. The information reproducing apparatus according to claim 1, wherein the database is arranged in a local storage of the information reproducing apparatus.

6. The information reproducing apparatus according to claim 1, wherein the database is arranged in a further storage that is accessible via a communication link.

7. The information reproducing apparatus according to claim 1, wherein the information reproducing device comprises:
an imaging unit providing video data of an environment to the processing unit for processing the video data and for displaying the video data on the display unit or a further display unit.

8. The information reproducing apparatus according to claim 7, wherein the imaging unit comprises two recording units that provide images used to generate a stereo image.

9. The information reproducing apparatus according to claim 8, wherein the information on the objects is superimposed on the video data on the display unit.

10. The information reproducing apparatus according to claim 1, wherein the information on the objects are graphical or alphanumeric and the information reproducing apparatus is configurable to display or hide the information in the display unit.

11. The information reproducing apparatus according to claim 1, wherein the information reproducing apparatus is portable or arranged in a transport means.

12. The information reproducing apparatus according to claim 1, wherein the information reproducing apparatus is a pair of binoculars, a camera, a PDA, a telephone, a computer, or an assistance system in a vehicle or aircraft.

13. A method for operating an information reproducing apparatus which comprises a display unit for displaying information, a processing unit coupled with the display unit and a position determining device, the method comprising:
determining, using the position determining device, a position and alignment of the information reproducing apparatus;
supplying a first signal representing the determined position and a second signal representing the determined alignment to the processing unit;
retrieving, by the processing unit, information on objects from a database;
processing, by the processing unit, the retrieved information on the objects, wherein the database comprises a plurality of information on objects of locations within a predefined spatial environment; and
determining, by the processing unit, information for objects in a direction of the determined alignment of the information reproducing apparatus;
transferring, to the display unit, the determined information for the objects; and
displaying, by the display unit, the transferred information.

14. The method according to claim 13, wherein the determination of the alignment occurs using a simultaneous carrier phase measurement of at least two antennas of the position determining device which are arranged relative to a satellite.

15. The method according to claim 13, wherein video data of an environment of the information reproducing apparatus is obtained and the information on the objects is superimposed on the video data on the display unit.
